(19) United States
(12) Patent Application Publication
(10) Pub. No.: US 2018/0297043 A1
(43) Pub. Date: Oct. 18, 2018

(54) SHOWER HEAD ASSEMBLY

(71) Applicant: Galvin Engineering Pty Ltd, Western Australia (AU)

(72) Inventors: Brian Bettany, Western Australia (AU); Konrad Pradzynski, Western Australia (AU)

(21) Appl. No.: 15/951,436

(22) Filed: Apr. 12, 2018

(30) Foreign Application Priority Data
Apr. 12, 2017 (AU) 2017901355

(51) Int. Cl. B05B 1/18; E03C 1/04; B05B 1/16

(52) U.S. Cl. CPC B05B 1/185; E03C 2201/30; B05B 1/16; E03C 1/0408

(57) ABSTRACT

The present disclosure provides a shower head assembly which comprises a housing having a water inlet, a shower outlet and a water outlet. Further, the shower head assembly has a conduit for water that is positioned within the housing and arranged such that a flow of water is directed from the water inlet to the shower outlet or to the water outlet. The conduit comprises an actuatable valve transferable between an actuated condition and a de-actuated condition. The shower head assembly is arranged such that, when the actuatable valve is actuated, the water flow is directed to one of the shower outlet and the water outlet, and when the actuatable valve is not actuated, the water flow is directed to the other one of the shower outlet and the water outlet.

### TECHNICAL FIELD

The present disclosure relates to a shower head assembly.

### BACKGROUND ART

Shower facilities in aged care centres and in the mental health area often need to have a wall mounted overhead shower outlet and separate hand-held shower head. Such dual shower facilities require complex plumbing, controls and water temperature regulators.

### SUMMARY OF THE DISCLOSURE

In a first aspect, the present invention provides a shower head assembly for mounting to a wall portion, the shower head assembly comprising:
a housing having a fixed shape, the housing having a water inlet, a shower outlet and a water outlet, the water outlet having a first water outlet coupling element arranged for coupling to a second water outlet coupling element;
a conduit for water, the conduit being positioned within the housing and being arranged to direct a flow of water from the water inlet to the shower outlet or to the water outlet, the conduit comprising an actuable valve that is arranged such that, when the first and second water outlet coupling elements are coupled to each other, the actuable valve transitions between an actuated condition and a de-actuated condition, whereby, when the actuable valve is actuated, the water flow is directed to one of the shower outlet and the water outlet, and when the actuable valve is not actuated, the water flow is directed to the other one of the shower outlet and the water outlet;
wherein an entire upper surface of the housing having the fixed shape is, when the shower head assembly is mounted to the wall portion, generally downward-sloping, whereby the shower head assembly is substantially ligature-resistant.

Embodiments of the present invention have the advantage that plumbing and controls are simplified. As the shower head assembly includes a conduit with an actuable valve, only one water inlet is required and a single water pipe for delivering water to the water inlet may be sufficient. Consequently, there may also be no need for two sets of water and temperature controls for the shower outlet and the water outlet, but a single set may be sufficient. Further, as the housing has the shower outlet, the water outlet and the water inlet, it is possible to have a single housing that does not have any projections or sharp corners, which improves anti-ligature characteristics. In addition, embodiments of the present invention seek to provide a safe and easy-to-use shower head assembly and facilitate a change from one shower type to the other shower type.

The second water outlet coupling element may be associated with a hand held shower head.

The shower head assembly may be arranged such that a member or projection of the second water outlet coupling element actuates or de-actuates the actuable valve when the first and second water outlet coupling elements are coupled to each other.

In one embodiment, the shower head assembly is arranged such that, when the actuable valve is not actuated, the flow of water is directed to the shower outlet, and when the actuable valve is actuated the water flow is directed only to the water outlet, wherein the actuable valve is actuated when the first and second coupling elements are coupled to each other.

In an alternative embodiment the shower head assembly is arranged such that, when the actuable valve is actuated, the water flow is directed to the shower outlet, and when the actuable valve is not actuated the water flow is directed only to the water outlet, wherein the actuable valve is de-actuated when the first and second coupling elements are coupled to each other.

The shower outlet may surround at least a portion of the water outlet. Alternatively, the shower outlet and the water outlet may be positioned immediately adjacent to each other or spaced apart from each other.

In one embodiment, the housing has at least two faces and is arranged such that the water inlet is positioned at a first face and the water outlet and the shower outlet are both positioned at a second face that is oriented substantially opposite to the first face.

The housing and a mounting region of a wall may entirely encapsulate the conduit when the housing is mounted onto the wall. Further, the shower outlet and the water outlet may be flush with housing portions. In one specific embodiment the housing does not have any portions projecting from a surface of the housing, which may have a smoothly curved general exterior shape.

In a second aspect, the present invention provides a shower head assembly comprising:
a housing having a water inlet, a shower outlet and a water outlet, the water outlet having a first water outlet coupling element arranged for coupling to a second water outlet coupling element;
a conduit for water, the conduit being positioned within the housing and being arranged to direct a flow of water from the water inlet to the shower outlet or to the water outlet, the conduit comprising an actuable valve that is arranged such that, when the first and second water outlet coupling elements are coupled to each other, the actuable valve transitions between an actuated and a de-actuated conditions, whereby, when the actuable valve is actuated, the water flow is directed to one of the shower outlet and the water outlet, and when the actuable valve is not actuated, the water flow is directed to the other one of the shower outlet and the water outlet;
wherein the housing and a mounting region of a wall entirely encapsulate the conduit when the housing is mounted onto the wall.

### BRIEF DESCRIPTION OF THE DRAWINGS

Notwithstanding any other forms which may fall within the scope of the disclosure as set forth in the Summary, specific embodiments will now be described, by way of example only, with reference to the accompanying drawings in which:

FIG. 1 is a cross section of a shower head assembly in accordance with an embodiment of the present invention;

FIG. 2 is a cross section of a coupling element in accordance with an embodiment of the present invention;

FIG. 3 is an exploded three dimensional view of a shower head assembly in accordance with an embodiment of the present invention;

FIG. 4 is a perspective view of an actuable valve in accordance with an embodiment of the present invention; and

FIG. 5 is a perspective view of a housing in accordance with an embodiment of the present invention.

### DETAILED DESCRIPTION OF SPECIFIC EMBODIMENTS

The present disclosure relates to a shower head assembly.

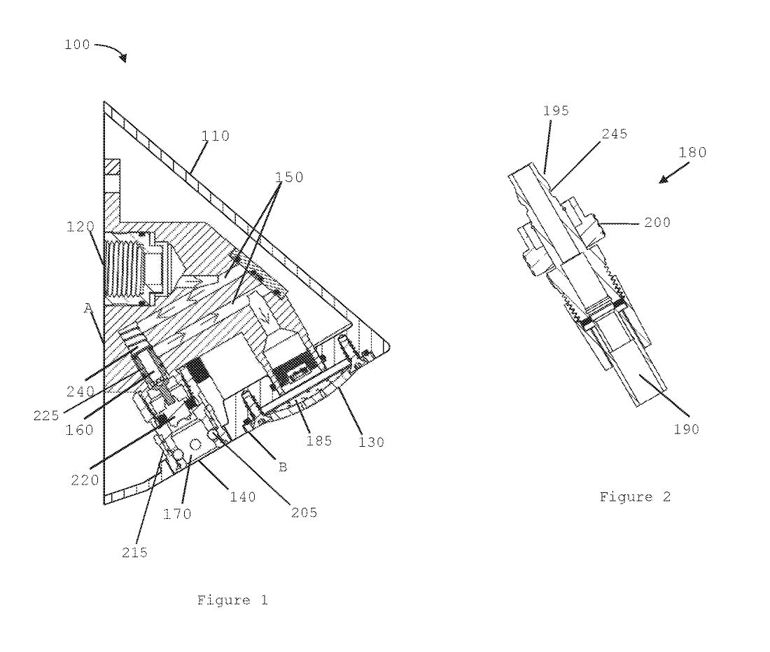

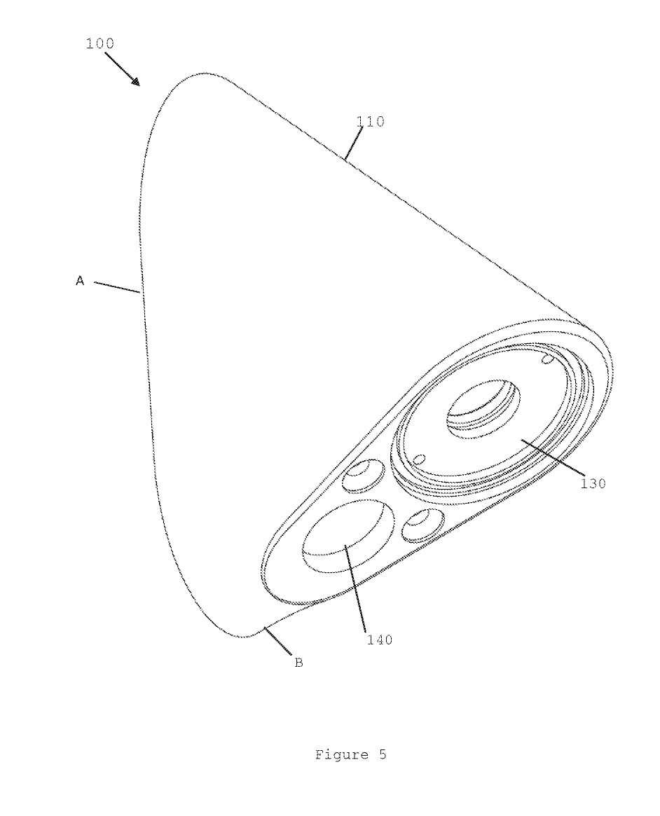

Specific examples of the shower head assembly will now be described with reference to FIGS. 1 to 5, and like components or features are assigned like reference numerals throughout the drawings.

There is shown a shower head assembly 100 comprising a housing 110 having a water inlet 120, a shower outlet 130 and a water outlet 140. The shower head assembly also comprises a conduit 150 for water, which is positioned within the housing 110. The conduit 150 is arranged such that a flow of water (as indicated by arrows shown in FIG. 1) is directed from the water inlet 120 to the shower outlet 130 or to the water outlet 140. The conduit 150 comprises an actuable valve 160 transferable between an actuated condition and a de-actuated condition. The shower head assembly 100 is arranged such that, when the actuable valve 160 is actuated, the water flow is directed to one of the shower outlet 130 and the water outlet 140, and when the actuable valve 160 is not actuated, the water flow is directed to the other one of the shower outlet 130 and the water outlet 140.

The water outlet 140 has a first water outlet coupling element 170 that is adapted for coupling to a second water outlet coupling element 180. The shower head assembly 100 is further arranged such that, when the first and second water outlet coupling elements 170, 180 are coupled to each other, the actuable valve is transitioned between the actuated and the de-actuated conditions.

The shower outlet 130 is in this example a shower rose 185 and a hose 190 connected to a hand held shower head is fitted to the second water outlet coupling element 180. A projection 195 of the second water outlet coupling element 180 actuates or de-actuates the actuable valve 160 when the first and second water outlet coupling elements 170, 180 are coupled to each other, as will be described in detail further below.

In the specific example shown in FIG. 1, the shower head assembly 100 is arranged such that the actuable valve 160 is initially not actuated, and the water flow is directed to the shower outlet 130. The actuable valve 160 is actuated by inserting the second water outlet coupling element 180 in the water outlet 140 to couple the first water outlet coupling element 170 with the second water outlet coupling element 180. Upon activation of the actuable valve 160, the water flow is directed only to the water outlet 140. The water is then allowed to flow through the first and second water outlet coupling elements 170 and 180, through the hose 190 to the hand held shower head (not shown).

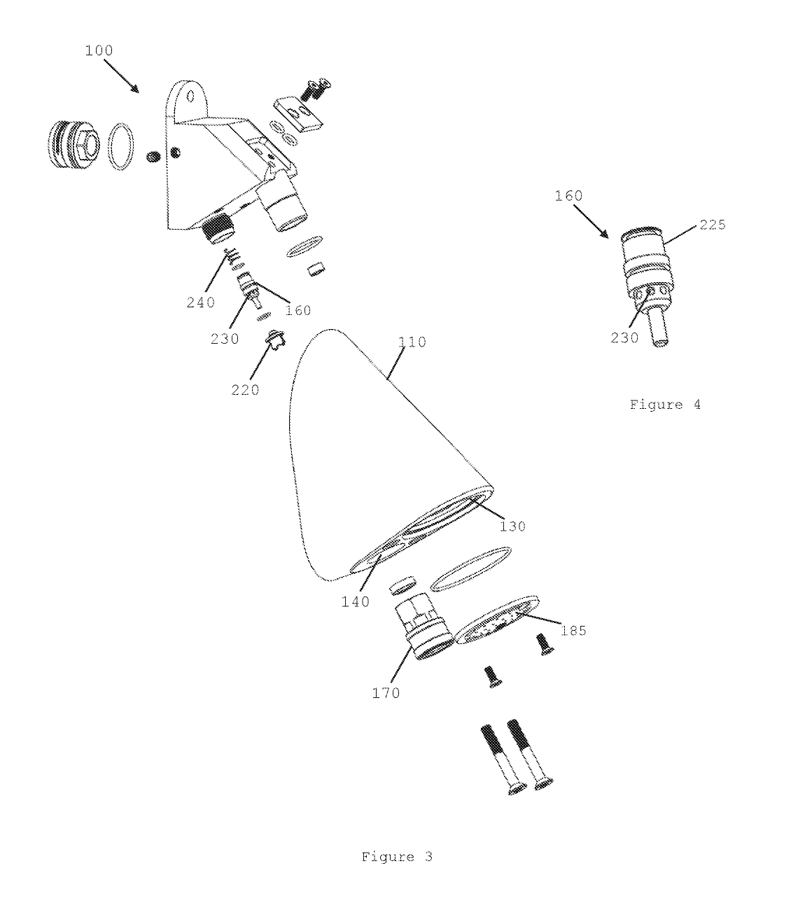

As shown on in more detail in FIGS. 2, 3 and 4, the second water outlet coupling element 180 comprises a ring 200 capable of sliding along the projection 195. The first water outlet coupling element 170 comprises ball bearings 205, a spring loaded sleeve 215 capable of sliding longitudinally towards the inside of the first water outlet coupling element 170 over the ball bearings 205, and a pin 220 coupled to a plunger 225 of the actuable valve 160. The actuable valve 160 comprises a series of radial holes 230 that are positioned such that in use water flows through the series of radial holes 230 when the valve 160 is in an actuated condition.

A spring 240 is positioned between a portion of the conduit 150 and the actuable valve 160, and biases the plunger 225 of the actuable valve 160 towards a condition in which the actuable valve 160 allows the flow of water towards the shower outlet 130. To allow the flow of water through the series of radial holes 230 of the actuable valve 160 towards the water outlet 140, the second water outlet coupling element 180 is coupled to the first water outlet coupling element 170 as will be explained below.

For coupling the first and second water outlet coupling elements to each other, the projection 195 of the second water outlet coupling element 180 is inserted into the first water outlet coupling element 170, and the ring 200 is slid along the projection 195 to push the spring loaded sleeve 215 over the ball bearings 205, which are then free to move. Further insertion of the projection 195 into the second water outlet coupling element 170 pushes the plunger 225 of the actuable valve 160 via the pin 220. The projection 195 further pushes the plunger 225 via the pin 220 against the biasing force of the spring 240, which allows throughput of water through the series of radial holes 230 and water flows then only towards the water outlet 140 while the flow of water towards the shower outlet 130 is blocked. Once the projection 195 is fully inserted into the first water outlet coupling element 170, the ball bearings 205 engage with a groove 245 on the projection 195, whereby the ring 200 is allowed to slide back along the projection 195, and whereby the spring loaded sleeve 215 slides back over the ball bearings 205. The second water outlet coupling element 180 is thus locked into position and coupled to the first water outlet coupling element 170. The water can then flow through the water outlet coupling elements 170, 180 through the hose 190 to the hand held shower head.

The second water outlet coupling element 180 can be de-coupled from the first water outlet coupling element 170 by pushing the ring 200 towards the spring loaded sleeve 215, whereby the spring loaded sleeve 215 is pushed towards the inside of the first water outlet coupling element 170, whereby the ball bearings are able to move out of contact with the groove 245 of the projection 195, and whereby the plunger 225 of the actuable valve 160 is biased by the spring 240 towards a condition in which the actuable valve 160 allows the flow of water towards the shower outlet 130 only.

The housing 110 comprises three faces. The water inlet is positioned at a face A, and both the water outlet 140 and the shower outlet 130 are positioned at a face B that is oriented substantially opposite to face A. The shower outlet 130 and the water outlet 140 are positioned spaced apart from each other at the face B, and the shower outlet 130 and the water outlet 140 are flush with housing portions of the housing 110.

The housing 110 is in use mounted onto a wall (not shown) such that the housing 110 and a region of the wall entirely encapsulate the conduit 150.

The housing 110 further does not have any portions projecting from a surface of the housing 110. The housing 110 has a smoothly curved general exterior shape, as best shown in FIG. 5, wherein the outer surface is chrome plated. The housing is specifically designed to minimise a risk of ligature, which is particularly important, for example, for patients suffering a mental illness, or for prisoners.

A single housing 110 having a water inlet 120, a shower outlet 130, and a water outlet 140, wherein a conduit and a valve are encapsulated within the single housing 110, and wherein the single housing 110 has a smoothly curved exterior shape, provides a shower head assembly 100 that presents improved anti-ligature characteristics, and therefore provides a substantially reduced risk of self-harm for patients in aged care or mental health services, for example, or for persons confined in prisons. Another particular advantage provided by the present shower head assembly 100 is that a single set of water and temperature controls may be sufficient. A transition between an overhead shower and a hand held shower is accordingly substantially facilitated, as well as is the use of the shower head assembly 100. This is again particularly advantageous for patients in aged care or mental health services, or for prisoners.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features in various embodiments of the invention.

Modifications and variations as would be apparent to a skilled addressee are determined to be within the scope of the present invention.

1. A shower head assembly for mounting to a wall portion, the shower head assembly comprising:
a housing having a fixed shape, the housing having a water inlet, a shower outlet and a water outlet, the water outlet having a first water outlet coupling element arranged for coupling to a second water outlet coupling element;
a conduit for water, the conduit being positioned within the housing and being arranged to direct a flow of water from the water inlet to the shower outlet or to the water outlet, the conduit comprising an actuable valve that is arranged such that, when the first and second water outlet coupling elements are coupled to each other, the actuable valve transitions between an actuated and a de-actuated conditions, whereby when the actuable valve is actuated, the water flow is directed to one of the shower outlet and the water outlet, and when the actuable valve is not actuated, the water flow is directed to the other one of the shower outlet and the water outlet; wherein an entire upper surface of the housing having the fixed shape is, when the shower head assembly is mounted to the wall portion, generally downward-sloping, whereby the shower head assembly is substantially ligature-resistant.

2. The shower head assembly of claim 1 wherein the housing has at least two faces and is arranged such that the water inlet is positioned at a first face and the water outlet and the shower outlet are both positioned at a second face that is oriented substantially opposite to the first face.

3. The shower head assembly of claim 1 wherein the housing and a mounting region of a wall entirely encapsulate the conduit when the housing is mounted onto the wall.

4. The shower head assembly of claim 1 wherein the water outlet and the shower outlet are flush with housing portions.

5. A shower head assembly comprising:
a housing having a water inlet, a shower outlet and a water outlet, the water outlet having a first water outlet coupling element arranged for coupling to a second water outlet coupling element;
a conduit for water, the conduit being positioned within the housing and being arranged to direct a flow of water from the water inlet to the shower outlet or to the water outlet, the conduit comprising an actuable valve that is arranged such that, when the first and second water outlet coupling elements are coupled to each other, the actuable valve transitions between an actuated and a de-actuated conditions, whereby, when the actuable valve is actuated, the water flow is directed to one of the shower outlet and the water outlet, and when the actuable valve is not actuated, the water flow is directed to the other one of the shower outlet and the water outlet;
wherein the housing and a mounting region of a wall entirely encapsulate the conduit when the housing is mounted onto the wall.
